(19) United States
(12) Patent Application Publication
(10) Pub. No.: US 2005/0018068 A1
(43) Pub. Date: Jan. 27, 2005

(54) Digital camera assembly with spacer

(76) Inventors: Ming-Chiang Tsai, Tu-chen (TW); Chun-Yu Lee, Tu-Chen (TW); Tsung-Wei Chiang, Tu-Chen (TW); Ga-Lane Chen, Fremont, CA (US)

Correspondence Address: WEI TE CHUNG;FOXCONN INTERNATIONAL, INC., 1650 MEMOREX DRIVE, SANTA CLARA, CA, 95050, US

(21) Appl. No.: 10/899,523

(22) Filed: Jul. 26, 2004

(30) Foreign Application Priority Data
Jul. 26, 2003 (CN) 03268104.6

(51) Int. Cl. H04N 5/225

(52) U.S. Cl. 348/335; 348/340

(57) ABSTRACT

A digital camera assembly (9) includes a base member (1), a lens module (2), a spacer (7), and an image sensor (4). The lens module includes a tubular body (5), and an objective lens system (6) retained in the tubular body. The lens module, the spacer and the image sensor are located in the base member in that order from top to bottom. In assembly, the tubular body is rotated down into a threaded hole of the base member until the spacer contacts supporting arms (12) of the base member. An axial length of the spacer is predetermined such that when the spacer contacts the supporting arms, an imaging plane of the image sensor is positioned at a focal distance of the objective lens system. The imaging plane is thus quickly and accurately positioned at the focal distance. The digital camera assembly is simple to assemble and reduces manufacturing time.

### BACKGROUND OF THE INVENTION

1. Field of the Invention

The present invention relates to digital cameras, and particularly to a digital camera assembly used in a portable electronic device such as a mobile phone or a PDA (Personal Digital Assistant).

2. Description of the Prior Art

Conventionally, a digital camera assembly used in a portable electronic device such as a mobile phone or a PDA is configured to-have only a single focal distance because of miniaturization constraints of the assembly.

FIG. 2 shows a conventional digital camera assembly 90 with a fixed focus. The digital camera assembly 90 includes a base member 10, an image sensor 40, a tubular body 50, an objective lens system 60, and a mounting ring 80. The objective lens system 60 is for projecting and focusing an image of an object onto the image sensor 40, and is mounted in a front end of the tubular body 50 by means of the mounting ring 80. The tubular body 50 is screwingly connected to the base member 10. In particular, an inner screw thread 30A is formed in an inner periphery of the base member 10, and an outer screw thread 30B is formed on an outer periphery of the tubular body 50. The tubular body 50 is rotated downwardly into the base member 10, with the outer screw thread 30B engaging with the inner screw thread 30A. During such rotation, the tubular body 50 is moved downwardly (or adjusted back upwardly) according to a predetermined pitch of the screw threads 30A, 30B. The image sensor 40 is mounted in a bottom of the base member 10, and is for receiving image data and transforming the image data into electronic signals.

To enable high quality photos to be taken, the imaging plane of the image sensor 40 should be positioned at the focal distance of the objective lens system 60. In assembling the digital camera assembly 90, a focalizing procedure is needed. The tubular body 50 is rotated so that it moves downwardly or upwardly, thereby adjusting the relative distance between the tubular body 50 and the base member 10. This is done until the image sensor 40 is located at the focus plane of the objective lens system 60. However, the focalizing procedure is laborious, and consumes much manufacturing time.

A new digital camera assembly which overcomes the above-described shortcomings is desired.

### SUMMARY OF THE INVENTION

An object of the present invention is to provide a digital camera assembly which is easily assembled to have a correct focal distance.

A digital camera assembly according to the present invention includes a base member, a lens module, a spacer, and an image sensor. The lens module includes a tubular body, and an objective lens system retained in the tubular body. The lens module, the spacer and the image sensor are located in the base member in that order from top to bottom. In assembly, the tubular body is rotated down into a threaded hole of the base member until the spacer contacts supporting arms of the base member. An axial length of the spacer is predetermined such that when the spacer contacts the supporting arms, an imaging plane of the image sensor is positioned at a focal distance of the objective lens system.

The main feature of the digital camera assembly is the spacer, which is located between the objective lens system and the image sensor. The axial length of the spacer enables the imaging plane of the image sensor to be quickly and accurately positioned at the focal distance of the objective lens system in assembly. Unlike in the prior art, there is no need for a focalizing procedure. Therefore the digital camera assembly is simple to assemble and can reduce manufacturing time.

Other objects, advantages and novel features of the invention will become more apparent from the following detailed description when taken in conjunction with the accompanying drawings.

### BRIEF DESCRIPTION OF THE DRAWINGS

FIG. 1 is a cross-sectional view of a digital camera assembly in accordance with the present invention.

FIG. 2 is a cross-sectional view of a digital camera assembly of the prior art.

### DETAILED DESCRIPTION OF THE INVENTION

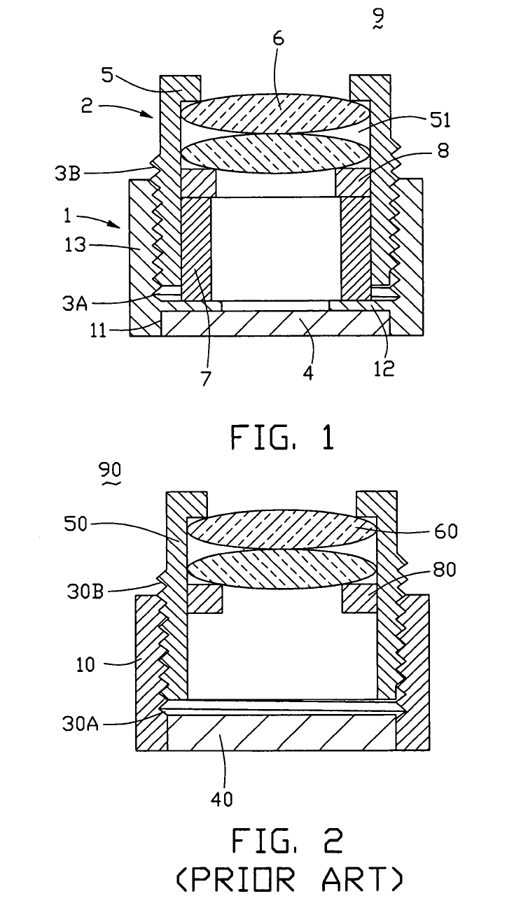

FIG. 1 shows a digital camera assembly 9 according to the present invention. The digital camera assembly 9 includes a base member 1, a lens module 2, a spacer 7, and an image sensor 4.

The base member 1 is cylindrical, and includes a circumferential wall 13, a pair of supporting arms 12, and a recess 11. The recess 11 is defined in a bottom of the base member 1, and is for receiving the image sensor 4 therein. The supporting arms 12 extend from opposite sides of an inner periphery of the wall 13, immediately above the recess 11. An inner screw thread 3A is formed in the inner periphery of the wall 13 above the supporting arms 12, thereby defining an inner threaded hole (not labeled). The threaded hole coaxially communicates with the recess 11 via a space (not labeled) between the supporting arms 12.

The lens module 2 is cylindrical, and includes a tubular body 5, an objective lens system 6, and a mounting ring 8. The tubular body 5 is cylindrical, and an outer screw thread 3B is formed on an outer periphery thereof. The outer screw thread 3B mates with the inner screw thread 3A of the base member 1 to securely fix the tubular body 5 in the threaded hole of the base member 1. The tubular body 5 has a hole 51 axially defined therethrough. The objective lens system 6 is for projecting and focusing an image of an object onto the image sensor 4, and is mounted in the hole 51 at a front end of the tubular body 5 with the mounting ring 8.

The spacer 7 is cylindrical, and has an outer diameter slightly less than a diameter of the hole 51 of the tubular body 5. An axial length of the spacer 7 is predetermined such that when the digital camera assembly 9 is assembled, an imaging plane of the image sensor 4 is located at a focal distance of the objective lens system 6.

The image sensor 4 may for example be a CCD (Charge Coupled Device). The image sensor 4 is used to receive image data of an object being photographed, and to transform the data into electronic signals. The electronic signals are transmitted to a signal processing section (not shown) of the digital camera assembly 9.

In assembly, the image sensor 4 is mounted in the recess 11 of the base member 1. The objective lens system 6 is mounted in the hole 51 at the front end of the tubular body 5 of the lens module 2 with the mounting ring 8. The spacer 7 is placed on the supporting arms 12 of the base member 1. The tubular body 5 is rotated into the threaded hole of the base member 1, with the outer screw thread 3B engaging with the inner screw thread 3B. The tubular body 5 thus moves rearward into the threaded hole until the mounting ring 8 contacts the spacer 7. Alternatively, the base member 1 and the lens module 2 may be oriented horizontally. The spacer 7 is inserted into the hole 51 until it contacts the mounting ring 8. The tubular body 5 is rotated into the threaded hole until the spacer 7 contacts the supporting arms 12.

Light from an object being photographed is projected and focused by the objective lens system 6 onto the imaging plane of the image sensor 4. The axial length of the spacer 7 ensures that the imaging plane is located at the focal distance of the objective lens system 6. Thus the object can be properly captured by the image sensor 4.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A digital camera assembly for use in a portable electronic device, comprising:
a base member;
a lens module;
a spacer; and
an image sensor,
wherein the lens module, the spacer and the image sensor are received in the base member, the spacer is located between the lens module and the image sensor, and an axial length of the spacer is predetermined such that an imaging plane of the image sensor is positioned at a focal distance of the lens module.

2. The digital camera assembly as claimed in claim 1, wherein the base member comprises a peripheral wall and at least one internal supporting member.

3. The digital camera assembly as claimed in claim 2, wherein the base member defines a recess in a bottom thereof, the recess receiving the image sensor.

4. The digital camera assembly as claimed in claim 3, wherein said supporting member extends from an inner periphery of the peripheral wall adjacent the recess.

5. The digital camera assembly as claimed in claim 4, wherein an inner screw thread is formed in the inner periphery of the peripheral wall adjacent said supporting member and distal from the recess, thereby defining an inner threaded hole of the base member.

6. The digital camera assembly as claimed in claim 5, wherein the threaded hole coaxially communicates with the recess via a space at said supporting member.

7. The digital camera assembly as claimed in claim 5, wherein the lens module comprises an objective lens system and a tubular body retaining the objective lens system therein.

8. The digital camera assembly as claimed in claim 7, further comprising a mounting ring engaged in the tubular body and retaining the objective lens system in the tubular body.

9. The digital camera assembly as claimed in claim 7, wherein an outer screw thread is formed on an outer periphery of the tubular body.

10. The digital camera assembly as claimed in claim 9, wherein the outer screw thread mates with the inner screw thread of the base member to securely fix the tubular body in the threaded hole of the base member.

11. The digital camera assembly as claimed in claim 7, wherein the tubular body axially defines a hole therein, and the objective lens system is mounted in a front end of the hole for projecting and focusing an image of an object onto the image sensor.

12. The digital camera assembly as claimed in claim 11, wherein the spacer is cylindrical.

13. The digital camera assembly as claimed in claim 12, wherein an outer diameter of the spacer is slightly less than a diameter of the hole of the tubular body.

14. A digital camera assembly for use in a portable electronic device, comprising:
a tubular base member defining a supporting arm;
a spacer supportably seated upon the supporting arm;
a lens module supportably located above said spacer; and
an image sensor located below the supporting arm,
wherein an imaging plane of the image sensor is positioned at a focal distance of the lens module.

15. A digital camera assembly for use in a portable electronic device, comprising:
a tubular base member;
a mounting ring coaxially located in the base member;
a lens module located within the base member and seated upon the mounting ring;
a spacer located below the mounting ring and abutting against the mounting ring; and
an image sensor located below the spacer,
wherein an imaging plane of the image sensor is positioned at a focal distance of the lens module.
